(19) United States
(12) Patent Application Publication
(10) Pub. No.: US 2012/0284917 A1
(43) Pub. Date: Nov. 15, 2012

(54) Sheet discreetly adapted for temporary but secure anchoring to ground

(76) Inventor: Chittaranjan N. Nirmel, Warfordsburg, PA (US)

(21) Appl. No.: 13/068,315

(22) Filed: May 9, 2011

(51) Int. Cl. A47G 9/06; G09F 23/00

(52) U.S. Cl. 5/417; 40/584

(57) ABSTRACT

Any commonly used sheet of any shape or size, e.g., a flat bed-sheet, blanket, tablecloth, bath-sheet, spare or selected fabric piece, or the like can be easily adapted per this invention to become very conveniently, securely, and safely anchored on a beach or lawn by simple, inexpensive anchors. During their intended use, and also when the sheet is being put to alternative use, the adaptation elements provided on the sheet are unobtrusive and mostly remain discreetly out of sight. Likewise, when the sheet is anchored to ground for use even under windy conditions it is only the top surface of the sheet that is primarily visible, and no parts of any of the anchors project above the sheet where they might pose a danger of tripping up unwary users, especially small children. The top surface of the sheet may be provided visually memorable colors, patterns, logos and messages, making the sheet easily recognizable and also suitable as a promotional item for an enterprise such as a business or an event such as a concert or a political or religious rally.

### FIELD OF THE INVENTION

This invention relates to discreet adaptations to a sheet for a user to quickly, easily, safely, and securely locate it temporarily to ground, e.g., on a beach or a lawn, for the user and others to rest thereon, where the sheet may also exhibit the user's choice of shape, color or pattern, or display a logo or insignia to promote a business. More particularly, this invention relates to structures and methods for discreetly and inexpensively adapting a sheet of any shape so that it can be quickly, easily, safely and securely located temporarily to ground—as at a beach or on a lawn—and also be comfortably usable at other times as a conventional bed sheet, tablecloth or the like as appropriate.

### BACKGROUND OF THE RELATED ART

It is common practice for beachgoers, picnickers, and concert fans to put down a flat sheet, e.g., a blanket, on a beach or a lawn to obtain a clean and comfortable surface on which to relax. Because they expect wind gusts to lift and disturb the placement of the sheet, people often place objects such as their shoes, bags, coolers, etc., at the corners and on the periphery of the sheet to weigh it down and hold it in place. Other common alternatives for thus weighing down the sheet include sand, rocks, driftwood, and the like. All of these are unsightly, may damage the sheet, and make portions of the sheet unavailable for comfortable use. Heavy objects resting on the sheet also present the risk that someone, especially children, will trip over them and get hurt.

There are numerous inventions that seek to address this particular problem. For example, U.S. Pat. No. 2,907,057 to Specht, teaches affixing grommets near the corners and along the sheet periphery and utilizing particularly formed anchors inserted via the grommets into underlying ground to temporarily locate the sheet. Grommets and portions of the anchors visible above them are unsightly. If made of metal, these items can become unbearably hot in strong sunlight—and may hurt both little children and adults with sensitive skin who contact them. A metal-grommeted sheet likely will damage both the washing machine and any other clothing washed with it. Plastic grommets, following exposure to strong sunlight, will eventually develop cracks with sharp edges that may snag and damage the users' clothing, e.g., swimwear.

Another example, which totally avoids grommets, is U.S. Pat. No. 5,832,672, to Griffiths et al. It teaches the use of stiff clamps temporarily clamped on to the sheet at selected locations, with corresponding anchors pushed through an opening in each clamp into the ground below. Unfortunately, this system leaves exposed hard edges of all the clamps above the sheet periphery, where they can trip up and hurt the feet and ankles of unwary persons—especially young children.

There is, therefore, a definite need for ways to securely locate a sheet of any shape horizontally to the ground so that nothing of any anchors being used is either visible or likely to pose a physical danger to persons encountering the sheet. Ideally, only the upper surface of the anchored sheet should be visible and all of it should be contactable by a user during its use. This feature can also provide a promotional benefit to beachside hotels and other businesses that may quite safely loan (or even cheaply sell) such sheets, distinctively marked to tastefully advertise the business enterprise, for their guests to enjoy at a nearby beach or park. Any solution that accomplishes this should do so safely, durably, simply, inexpensively and in a user-friendly manner.

For persons of modest means, it would be particularly beneficial to adapt sheets of the kind found in most homes, e.g., flat bed sheets, blankets, old curtains, tablecloths, and bath sheets—so that they may also be readily used on a beach, lawn, etc., as described above, yet with the adaptations formed to be unobtrusive and virtually unnoticeable. Such discreet adaptations may be included on new sheets of the same kind to enhance their utility.

The present invention provides exactly such a solution that satisfies all these existing needs.

### SUMMARY OF THE INVENTION

It is a principal object of this invention to provide discreet and inexpensive improvements, to a sheet of any shape, to facilitate easy and safe anchoring of the sheet to ground by a plurality of anchors.

This object is realized by providing to a sheet having a top side, a bottom side and a periphery, the improvement comprising:

a plurality of pieces of flexible tape, each tape piece having respective first and second ends and a predetermined length between the two ends, strongly attached at respective first and second end portions to the bottom side of the sheet at selected locations close to the periphery, with an intermediate portion of each tape piece left unattached for engagement with a respective anchor; whereby, when the sheet is anchored to ground with its top side uppermost, only the sheet will be visible during such use.

It is another object of this invention to provide improvements to a sheet of any shape, having a top side, a bottom side, a periphery, and at least one corner in the periphery, to durably adapt the sheet for secure temporary location to ground by a plurality of anchors.

This object is realized by a simple modification to improve the sheet, wherein the improvement comprises:

a length of a flexible tape attached strongly along the entire periphery on the bottom side of the sheet, with portions of the tape left unattached to the sheet at selected locations on the periphery and at each corner to form respective anchor-engagement loops to securely engage corresponding anchors thereat for temporary anchoring to ground thereat.

It is a related object of this invention to provide an inexpensive but attractive and useful item, for promoting an enterprise or event, e.g., a business, charity, political rally, outdoor concert, public gathering, or the like.

This object is realized by providing an inexpensive promotional item, comprising:

a sheet having a top side, a bottom side and a periphery;

a plurality of pieces of flexible tape, each tape piece having respective first and second ends and a predetermined respective length between the two ends, strongly attached at respective first and second end portions to the bottom side of the sheet at selected locations close to the periphery, with an intermediate portion of each tape piece left unattached for engagement with a respective anchor, so that when the sheet is thereby anchored to ground with its top side uppermost only the sheet will be visible;

a plurality of anchors, wherein each anchor comprises a body consisting of a head portion and a leg portion, the leg portion being formed with a distal end securely engagable with a corresponding tape piece and securely locatable into ground to anchor the sheet flat to the ground thereat; and

the top surface of the sheet is provided with at least one of an easily remembered and recognizable color and a distinctive pattern, the same being selected to visually promote the enterprise or event.

Yet another object of this invention is to provide a method of promoting public awareness of an enterprise or event, and of thereby building customer and patron goodwill.

This object is realized by providing a promotional method, comprising the steps of:

adapting a sheet for engagement with a plurality of ground anchors, by permanently attaching to the sheet adjacent its periphery a selectively distributed corresponding plurality of strong flexible tape pieces, the tape pieces being affixed to the sheet at their respective end portions with respective intermediate portions of the tape pieces left unattached to define anchor-engagement loops to engage with respective anchors thereat;

providing the plurality of ground anchors sized and shaped to engage with individual anchor-engagement loops and with ground beneath the sheet during use;

providing on the top of the sheet a distinctive visual message promoting the enterprise or event, and

purposefully making the adapted sheet available to potential users,
wherein the material of the tape pieces is selected to have a color and a texture appropriate to a color and the texture of the sheet, and
wherein the anchors during use are disposed entirely out of sight.

These and other related objects of this invention are best understood with reference to the drawings and detailed description included herewith

### BRIEF DESCRIPTION OF THE DRAWING FIGURES

FIG. 1 is a perspective view of a prior art structure taught by Specht in U.S. Pat. No. 2,907,057.

FIG. 2 is a perspective view of a prior art structure taught by Griffiths et al. in U.S. Pat. No. 5,832,672.

FIG. 3 is a perspective view of a sheet according to one aspect of this invention, in a partially anchored state on a sandy beach with some anchors yet to be disposed in their fully-functional positions.

FIG. 4 (A) is a bottom plan view of a corner of a sheet, showing a folded corner tape piece attached to engage the corner with an anchor according to a first embodiment of this invention; FIG. 4 (B) is a bottom plan view of a side of the same sheet, showing a folded side tape piece attached to engage the side with an anchor according to a second embodiment of this invention; and FIG. 4 (C) is a perspective top plan view of the sheet corner per FIG. 4 (A) in its engaged disposition with respect to underlying ground.

FIG. 5 is a side elevation view, with the sheet bottom uppermost, to clarify certain dimensional relationships that improve retention of an anchor within a side or corner folded tape piece in the first and second embodiments of this invention.

FIG. 6 is a bottom plan perspective view of a corner of a sheet, showing a cross-corner tape piece attached to the sheet bottom to engage with an anchor according to a third embodiment of this invention.

FIG. 7 (A) is a bottom plan view of a side of the sheet, showing a longitudinally aligned side tape piece attached to the sheet bottom to engage with an anchor according to a fourth embodiment of this invention; FIG. 7 (B) is a side elevation view, with the sheet top uppermost, showing the sheet disposed flat relative to the ground into which it is anchored according to the fourth embodiment of this invention; and FIG. 7 (C) is a side elevation view of a side of the sheet, with the bottom uppermost, to clarify certain dimensional relationships that ensure retention of an anchor within a side or corner tape piece in the third and fourth embodiments.

FIG. 8 is a partial bottom plan view of a corner portion of an improved sheet that may have either a selectively sized corner tape piece at each corner anchor location, or a long continuous length of tape along the entire periphery of the sheet with corner tape portions formed into respective corner anchor loops.

FIG. 9 is a partial bottom plan view of a side portion of an improved sheet that may have either a selectively sized side tape piece at each side anchor location, or a long continuous length of tape along the entire periphery of the sheet with side tape portions formed into respective side anchor loops.

FIG. 10 is an exemplary anchor, showing three exemplary means for enhancing retention of the anchor to ground during use.

FIG. 11 is a partial bottom plan view of a corner of an improved sheet, in which a length of tape is incorporated into an end seam with an extended portion of the tape at each end folded over to form an anchor-engaging loop.

FIG. 12 is a partial bottom plan view of a corner of an improved sheet that has a selectively sized corner tape piece folded over and affixed to form an anchor-engaging loop aligned with the longer side of the improved sheet.

FIG. 13 is a partial bottom plan view of a corner of an improved sheet that has a selectively sized corner tape piece folded over and affixed to form an anchor-engaging loop aligned with the shorter side of the improved sheet.

FIG. 14 is a partial cross-sectional view of an improved sheet that has a selectively sized tape piece folded over and affixed with its end portions disposed on opposite sides of the sheet to sandwich the sheet and form an anchor-engaging loop normal to the sheet edge (at a corner or at a side of the improved sheet).

### DESCRIPTION OF THE PREFERRED EMBODIMENTS

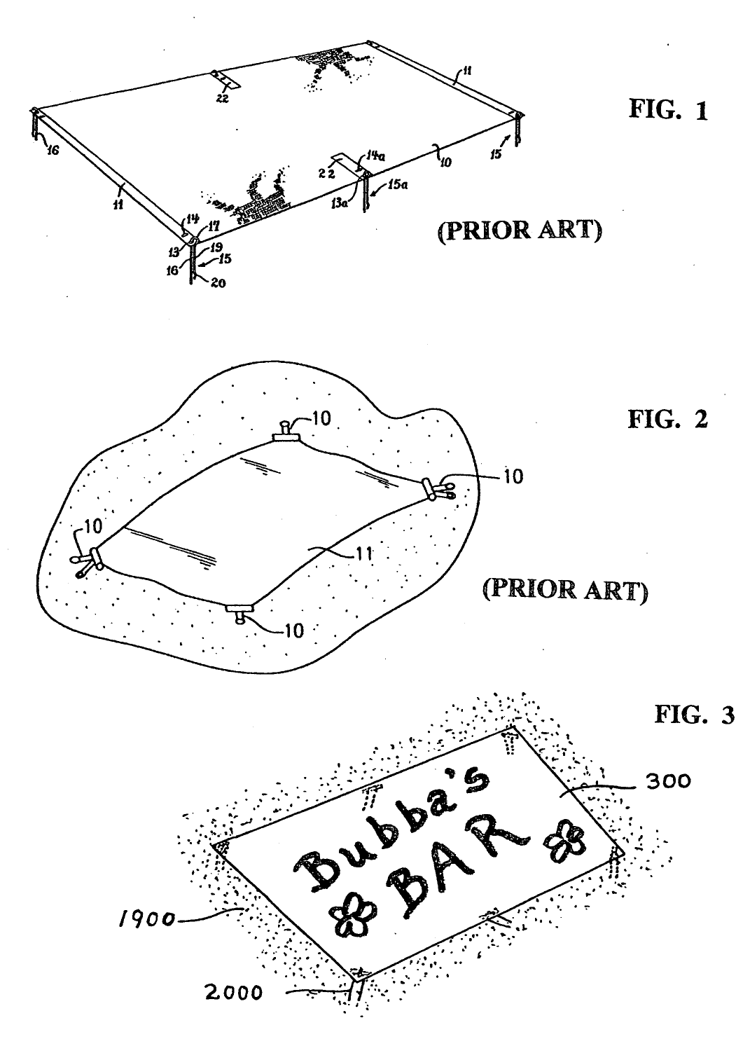

FIG. 1 shows a known beach sheet anchoring arrangement, as taught in U.S. Pat. No. 2,907,057 to Specht, in which a grommeted sheet 10 is anchored by corresponding anchors 15 passed in part through the grommets 13 or 13a into underlying ground. The grommets and upper portions of all anchors remain visible and user-contactable during use.

FIG. 2 shows another known beach sheet anchoring arrangement, as taught in U.S. Pat. No. 5,832,672 to Griffiths et al., in which an ungrommeted sheet 11 is held by clamps 10 that largely remain above the sheet, at its corners and along its sides, and are themselves located to ground by anchors passing through holes in the lower leg of each clamp—an arrangement in which a lot of the hardware, virtually all of the clamp bodies, remains above the sheet during use where it can trip up and hurt the unwary.

In stark contrast to these and other examples in the prior art, as seen generally in FIG. 3 the present invention ensures that practically any sheet 300 can be adapted to be anchored to ground 1900 by simple anchors 2000 that are disposed to remain totally below the level of the sheet 300 during such use, with the needed adaptations to the sheet remaining virtually unnoticeable and unobtrusive at other times.

As indicated in FIG. 3, by putting their business logo, trademark, service mark, or name—“Bubba's Bar”—on sheet 300, a waterside business such as a beachside bar, hotel, eatery, pool hall, or the like, can advertise their offering to the public by lending, renting or selling such sheets at an affordable price—particularly during occasions like local concerts, semester breaks and the like when their patrons spend freely. Corporations, law firms, religious orders, environmental groups, and others who organize off-site retreats, at or away from a beach, may similarly find it beneficial to give away or sell cheaply such strong, durable, colorful sheets to improve staff morale and customer or patron goodwill.

Basically, with variations discussed in detail below, this invention employs relatively small amounts of widely available, inexpensive, strong, flexible ribbon or tape made, for example, of cotton, polyester, or blended fiber, preferably between ¼ and ¾ inch wide, sewn on to the corners and sides of the bottom of the selected sheet to form anchor-engaging loops. These loops may be defined entirely by the tape or by cooperation between the tape and the sheet. The loops may be selectively sized to permit easy engagement with the anchors by a user but so as to impede unintended separation from the anchors when it is very windy, and the sheet is therefore flapping around strongly, while the user is removing the sheet from its anchored position.

To ensure that the loops and the stitching applied to affix them to the sheet remain physically unobtrusive, and also barely noticeable visually, they should ideally be of the same surface texture and color as the sheet itself. If a differently colored tape is deemed particularly desirable, for reasons of cost, economy or strength, it may be covered with a small piece of the same material as the sheet—and thus made to visually blend in with the sheet itself. If the sheet has a pattern to it, with some care this solution should accommodate it too.

Although the generic term “sheet” is used herein, persons of ordinary skill in the related arts are expected to understand that the sheet itself may comprise more than one thickness of the same or different materials, and that it may include a thermally insulating and/or waterproof layer, as may be most appropriate for a particular application. This inherent adaptability of the present invention would enable a user, for example a physically fit skier, to anchor a sheet in the lee of a windbreak and sunbathe even on snow-covered ground.

The “tape”, likewise, may comprise a waterproof material.

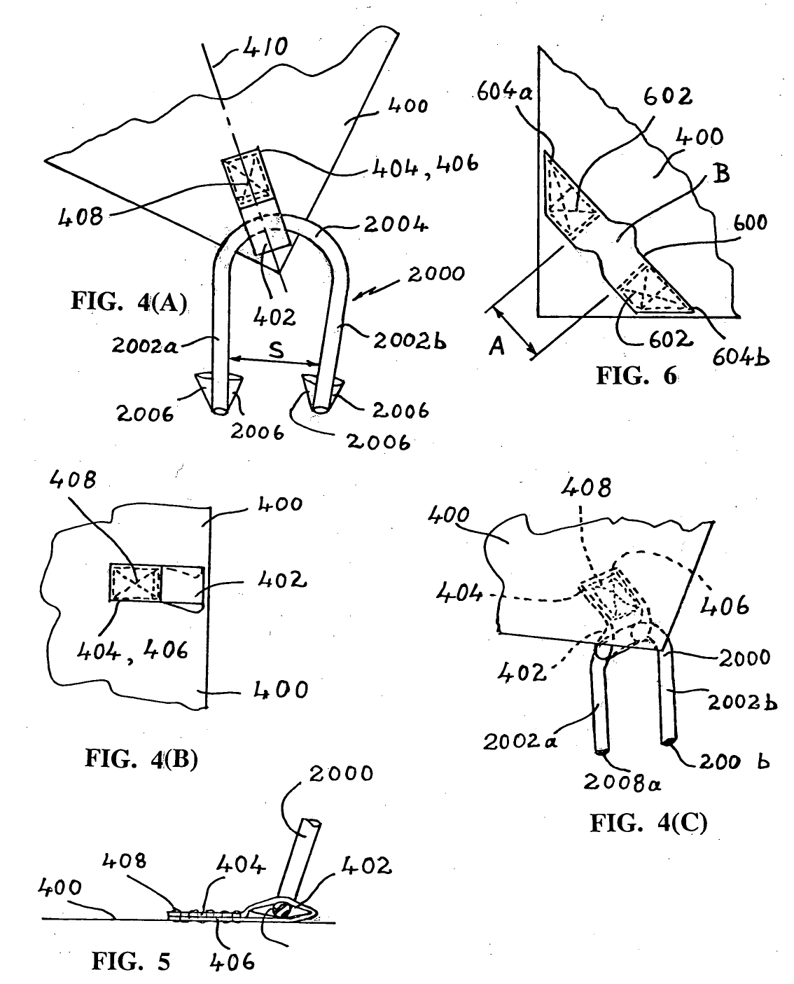

In a first preferred embodiment, as best seen in FIGS. 4(A), (B) and (C), at a corner of a rectangular sheet 400 a closed corner tape loop 402 (also referred to as “corner loop” for brevity) is formed by folding over a corner piece of tape and sewing or otherwise strongly connecting the end portions 404, 406 of the tape piece one over the other to the sheet. Strong polyester or nylon thread is recommended for long-lasting stitching 408, particularly for durability when subjected to prolonged exposure to strong sunlight.

Note that the folded-over corner tape piece is preferably aligned with the bisector 410 of the corner angle to help even out any stress transmitted from the anchor to the criss-crossing fibers of the sheet fabric. If the sheet were of another shape defined by straight sides, e.g., a pentagon or a hexagon, the same principle could be use advantageously at its corners.

FIG. 4(B) shows a similarly constructed side tape loop 402 (also referred to as “side loop” for brevity) affixed at another selected location at the side of the same sheet 400, oriented perpendicular to the side edge. Most sheets made from fabric of suitable width, e.g., 60-96 inches wide, will likely have their elongate edges inherently finished, i.e., they will not need to be hemmed there to avoid unraveling of the fabric. On the other hand, at the ends of pieces cut from a substantial length of fabric there is usually a need to hem the edges to avoid fabric unraveling. Depiction of such hems is omitted in some of the drawing figures for simplicity.

Polygonal or circularly shaped sheets usually are hemmed all around the periphery. If the sheet happens to have a curved periphery, i.e., it is a circle or an oval, then all the tape loops will, in effect, be “side loops”, and preferably should be affixed to the sheet aligned normal to the local periphery for maximum effectiveness.

FIG. 5 shows a side view of such a side tape loop 402, with an anchor shown in cross-section as it would be located inside the loop. Referring to FIGS. 4(B) and 5 together, it should be clear that the side loops (as well as corner loops as indicated in FIG. 4(A)) are all dimensioned and located so that all of them remain entirely within the perimeter of sheet 400 whether or not anchors are engaged in the loops. This is important, because when the sheet is not anchored, and may be in use in another role, e.g., serving as a bed sheet or a tablecloth, when the sheet top is uppermost this will ensure that the loops can be disposed so that they remain totally out of sight. Regular sheets that serve other purposes in a home also may thus be discreetly adapted for use as anchorable sheets for occasional use on the beach or lawn. Furthermore, when used outside, the anchored sheet totally covers up the anchor-engaged loop beneath. Once the user has forced the anchor down into underlying ground to a level just below the sheet, the sheet itself should naturally lie totally in contact with the ground—with the uppermost portion of the anchor just below it and thus totally invisible. All that should be visible then is the sheet itself, firmly secured to ground.

When the user wishes to remove the sheet 300 from an anchored location, all that is necessary is that the sheet edge above an anchor be engaged with a finger and a slow, deliberate, upward tug be applied to it, and thus to the loop and anchor under it, to lift out the anchor from the ground. This process must be repeated at the other anchors. If the user wishes to leave the anchors engaged with their respective loops (both at the sheet corners and the sides) he or she can simply put the sheet and still engaged anchors away right then. Alternatively, e.g., if the sheet 300 is to be washed, each anchor can be carefully worked out of its loop and packed away. The sheet by itself can then be washed with only its soft tape loops and fabric contacting any other items being washed with it.

FIG. 4(A) shows an anchor 2000 that has two elongate generally parallel legs 2002a, 2002b contiguous with a top portion 2004 which conveniently may be curved. Such an anchor 2000 can be made inexpensively from a metal, a composite, or any relatively stiff but flexible plastics material, e.g., the kind of thermally-moldable plastics used to make stiff clothes hangers for coats and other heavy garments.

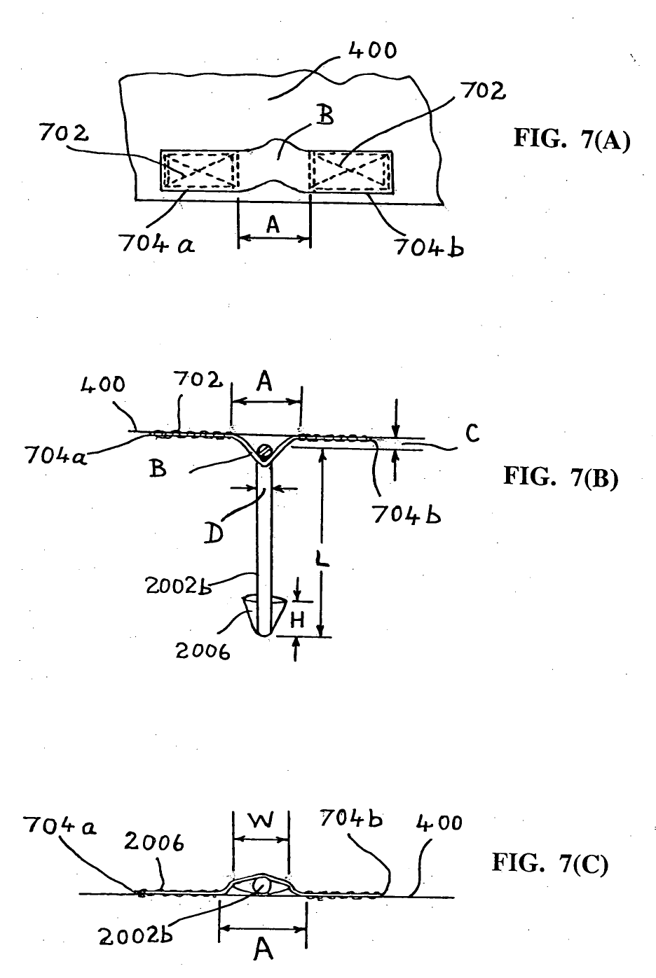

As best understood with reference to FIGS. 4(A) and 7(B), diameter “D” for the legs 2002a, 2002b of an anchor made of such plastics material preferably is about ¼ inch. The overall length “L” of an anchor suitable for most uses as described is in the range about 3 to 6 inches, and a suitable separation “S” of the legs is in the range about ¾ to 1½ inches. Other dimensions may prove more suitable for particular applications, e.g., for very large sheets that are temporarily anchored to ground in very windy locales.

The anchor 2000 shown in FIG. 4(A) preferably has two diametrically opposed barb-like extensions 2006 at the distal ends of legs 2002a, 2002b. These, like the distal ends 2008a, 2008b themselves (as best seen in FIG. 4(C)) are provided smoothly rounded edges and ends to reduce the likelihood of injury to a person accidentally stepping on an anchor. Extensions 2006 are shaped so that while it is not particularly difficult for a user to forcibly insert the anchor 2000 so equipped into ground, it is much harder for gusts of wind to lift the anchors out and release the sheet from ground. The overall maximum periphery of a barb-ended leg 2002a or 2002b must be slightly smaller than the overall inside periphery of a corner or side loop 402. This will ensure ease of insertion and withdrawal of such a barbed end of an anchor through the loop, and will also serve to significantly reduce the likelihood of such a separation occurring unintentionally, e.g., while the user is picking up the sheet 400 from ground during a strong wind that causes the sheet to flap severely.

FIG. 6 shows an alternative embodiment, in which a tape piece 600 is affixed across a corner of sheet 400 by stitching 602 on ends 604a, 604b. Tape piece 600 is preferably affixed symmetric with the corner itself to even out any physical stress put upon the fabric of sheet 400 there over time and use. Note that the longitudinal dimension “A” of the sheet material between the closest stitching is smaller than the counterpart longitudinal dimension of the tape portion “B” directly adjacent to it. The total length “A+B” of a loop, so formed by cooperation between the unaffixed portion of the tape piece and the corresponding length of fabric, must be slightly larger than the maximum outside periphery of the barb-ended extensions to permit their convenient insertion and withdrawal from the corner loop so formed. Note also that when the sheet corner is anchored by such a loop, the topmost part of the anchor will be below the level of the sheet so that the flat sheet there will be all that is visible.

As best seen in FIGS. 7(A), 7(B) and 7(C), there is a similar alternative form for a side loop formed by cooperation between the unaffixed portion of the side tape piece and the adjacent corresponding length of fabric. In this embodiment, strong stitching 702 affixes end portions 704a, 704b to sheet 400 so as to leave a length “A” of its fabric free between adjacent stitching. However, the length of the unaffixed tape material corresponding to this is “B” and is made somewhat longer to ensure that when sheet 400 is anchored here it will lie flat to ground while the topmost portion of the anchor will lie a short distance “C” below and not be visible. The maximum lateral span of the barbed end of an anchor leg 2002a, 2002b is “W” and the barb height is “H”, each preferably in the range about 0.5 to 1.00 inch.

FIG. 8 shows yet another embodiment of a corner loop 800, particularly suitable for inclusion on a sheet 400 that has a continuous length of a reinforcing tape affixed around its entire periphery, e.g., by stitching 802. The fact that the tape is meant to be peripherally continuous is indicated by double headed arrows in both FIGS. 8 and 9. Portions of the tape adjacent the corner are even more firmly attached to sheet 400 by additional amounts of stitching 804a, 804b. Corner loop 800 should be sized to accommodate any barbed-ended anchors as previously explained, and is sized and located so that it remains out of sight when the sheet is anchored and remains unobtrusive when the sheet is perhaps in other use, also as explained before.

FIG. 9 shows a corresponding side loop 900 provided at suitable locations in the long length of tape circumscribing the periphery of sheet 400. Extra stitching 904a, 904b is provided for strong affixation of the corner tape piece to sheet 400 on opposite ends of loop 900. The dimensioning, disposition and benefits of such an anchoring side loop defined in a continuous long tape are as explained earlier, and so will not be repeated. Note that side loops in this embodiment can be formed and will function exactly as the side loop shown in FIG. 7(A) that is defined by cooperation between an unaffixed portion of the tape of length “B” and the corresponding length “A” of the fabric of the sheet.

As will be readily understood, sheets of other shapes, e.g., pentagons, hexagons, circles, ovals, stars, etc., can be easily adapted in accordance with this last-described embodiment by either kind of loop as shown in FIGS. 8 and 9 as deemed most appropriate. Any such non-rectangularly shaped sheet is likely to have a sewn hem, hence the continuous elongate peripheral tape can easily be incorporated into the hem during its creation or it can even be sewn on around the periphery, over the hem if one exists, afterwards, e.g., if a circular or oval table cloth or furniture throw is being adapted for anchored use on a beach.

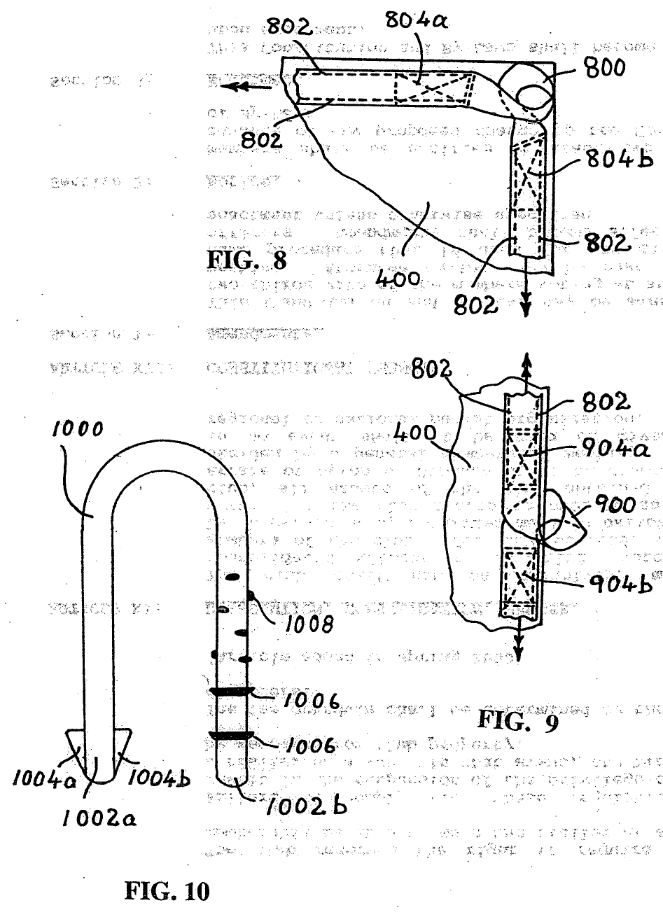

In FIG. 10 there are shown three very inexpensive yet convenient ways to improve the anchor. Any of these choices, by itself or in cooperation with others, should make the anchor legs obtain and maintain a higher degree of retention to ground during use than that available with totally smooth legs. Other geometries for the anchor body itself may be considered by a user, e.g., those with only a single leg to be inserted into ground, one with a round flat head, etc., but all such obvious variations would benefit from the proposed enhancements to the inserted leg portion(s).

Thus, on exemplary two-legged anchor 1000, there is shown first a double barbed end provided with barb-like extensions 1004a, 1004b, the structural and functional needs and details of which are as previously described.

A second alternative ground-retention enhancement is provided by a plurality of spaced-apart rings 1006 that have generally barb-shaped cross-sections protruding outwardly of leg 1002b. They would permit easy insertion of the enhanced anchor into ground while enhancing its retention in ground during use. The number, size and separation of these would be matters of design choice best made by the manufacturer of such anchors.

A third alternative, for exactly the same purpose, is to provide a plurality of raised bumps or extensions 1008 of simple geometry along each leg of the anchor. These too would allow ease insertion of the anchor into ground while enhancing its retention there during use.

For backpackers, hikers, and older persons who do not relish carrying heavy items, a light-weight yet strong, easily washed, readily recognized adapted sheet would be desirable. Relatively thin adapted sheets made from polyester, nylon, and assorted blends of the same with natural fibers, all would be suitable for them. On the other hand, there are strong people who can comfortably drag along a cart loaded with fairly heavy food containers, boom-boxes, ice chests, beverage bottles and the like for a day at the beach. For such people, weight is not a serious concern, and they might find it convenient to use heavier and more substantial adapted sheets made of denim, canvas, or padded material for extra comfort.

Children, and even adults, often forget where they leave their stuff on a heavily occupied beach, so it would help them to have their adapted sheet brightly colored and/or boldly patterned so as to be easily remembered and recognized. If there are many visually similar adapted sheets on a particular segment of a beach, due to heavy promotional attempts by a business as suggested earlier, a pennant of distinctive design and mounted on a tall rod may be included with each adapted sheet for ease of recognition by a user. It may be located immediately adjacent the sheet below.

FIG. 11 shows how an adapted sheet 1100 may be provided an extended length of tape 1102 incorporated into an end seam 1004, to thereby strengthen the sheet end, with end portions of the tape (only one is shown) being folded over and incorporated into the seam ends to create respective anchor-engaging loops at each corner. As noted earlier, by choosing the color of tape 1002 and stitching 1010 to be the same as that of sheet 1100 the much smaller soft tape loop 1008 may be made virtually unnoticeable. When loop 1008 is engaged with an anchor inserted into the ground, it will be out of sight with only the sheet being visible directly over and flat to ground.

FIG. 12 shows how a corner of a sheet 1200 may be adapted by affixing to its bottom side, by stitching 1202, a very simple anchor-engaging loop 1204 aligned with the longer side 1206. Both end portions of the tape piece are on the same side of the sheet, and by selecting the color and texture of the tape piece carefully the loop may be made almost unnoticeable at all times.

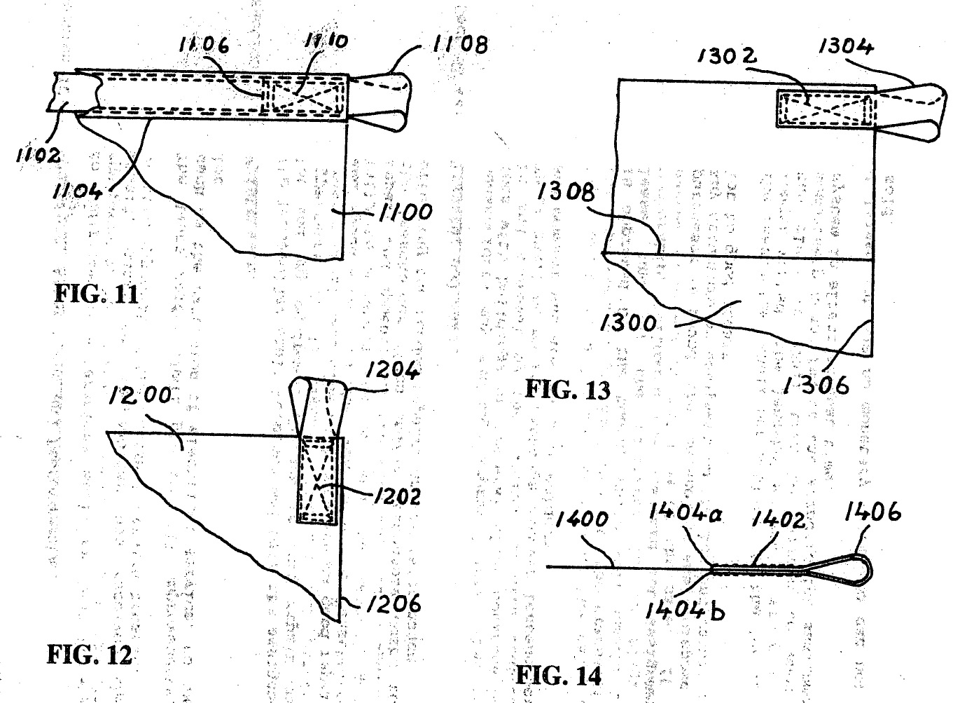

FIG. 13 similarly shows how a corner of a sheet 1300 may be adapted by affixing to its bottom side, by stitching 1302, a very simple anchor-engaging loop 1304 aligned perpendicular to the longer side 1306 of the sheet. Note that if thus improved sheet 1300 is normally used as a flat bed-sheet it is likely to have at one end a wide end seam 1308. Both end portions of the tape piece are on the same side of the sheet and, as noted above, by selecting the color and texture of the tape piece carefully the loop may be made almost unnoticeable at all times.

FIG. 14 shows in cross-sectional view a portion of a sheet 1400 adapted for anchor-engagement by affixing to it a tape piece folded over and stitched to the sheet by stitching 1402. In this embodiment, the end portions 1404a and 1404b are disposed to be on opposite sides of the sheet so as to sandwich it, while leaving an unaffixed portion of the tape free to form anchor-engaging loop 1406. As persons of ordinary skill in the art will immediately appreciate, while this embodiment requires the least amount of labor and tape material to adapt any sheet, it does leave a small amount of the tape visible on both sides of the improved sheet. This can be ameliorated by appropriate selection of the material, texture, and color of the tape as discussed above. It should also be appreciated that this technique for adapting a sheet, to make it easily and inexpensively engageable by ground anchors, can be used at corners and at either straight or curved sides of any sheet with equal facility.

The embodiments of FIGS. 11-14 may be most found particularly suitable for dedicated “outside” sheets, i.e., strong sheets that are expected to be used almost exclusively in the open for sunbathing and the like. If used solely (or at least primarily) in this context, the fact that the small loops are visible when the sheet is not actually anchored to ground may be totally acceptable to most users. The sizing of these tape loops, e.g., to accommodate particular anchors, is considered a matter of design choice.

There are other logical and highly beneficial uses for this invention. For example, certain public interest groups act to increase awareness of AIDS awareness by periodically holding rallies and outdoor events at which large sentimentally-significant quilt assemblies are laid out in public places where they may be seen by passersby. These quilt displays typically comprise large numbers of individual square quilted panels created by caring, involved, and artistically talented participants, the panels sometimes being securely interconnected for the display.

Unfortunately, such a large interconnected quilt assembly, while helpful in providing a neat arrangement of the individual panels, is very heavy and cumbersome to present and then to retrieve and pack for transportation, storage and/or display elsewhere. The present invention provides a very convenient alternative: in which individual (square or rectangular) quilt elements are provided with suitably sized tape loops at least at each corner, whereby up to four adjacent quilt panels could be coupled at abutting corners, in obvious manner, by simultaneous engagement of their corner loops with mutually shared corner anchors. Such an accretion of interconnected individual panels can be readily extended as deemed best under prevailing circumstances. Since each such panel would be individually anchored, it would separately resist displacement by wind gusts.

A further benefit is that at the scheduled end of the event, or if the weather suddenly turns nasty or it rains, the relatively small individual quilt elements could be retrieved and made safe very swiftly; and their subsequent return to respective owners would be made relatively easy. Such a technique would also allow latecomers to incorporate their quilted elements to the existing quilt assembly from its outside, as they arrive, even if they do not have a previously reserved location for their particular quilt element.

Obvious modifications and useful application of the disclosed embodiments of this invention will no doubt occur to others, and all such are intended to be comprehended within the scope of this invention which is limited solely by the appended claims.

1. An improved sheet having a top side, a bottom side and a periphery, adapted for secure location to ground by a plurality of anchors, wherein the improvement comprises:
a plurality of pieces of flexible tape of predetermined width, each tape piece having respective first and second ends and a predetermined respective length between the two ends, strongly attached at respective first and second end portions to the bottom side of the sheet at selected locations close to the periphery, with an intermediate portion of each tape piece left unattached for engagement with a respective anchor,
whereby,
when the sheet is anchored to ground with its top side uppermost, with the anchors driven into the ground to a level just below the sheet, only the sheet will be visible during such use.

2. The improved sheet according to claim 1, wherein:
the unattached intermediate portion of each tape piece is longer than a separation along the sheet between the attached portions thereof, so that the sheet during use can be disposed flatly above an anchor engaging each tape piece.

3. The improved sheet according to claim 1, wherein:
at least one of the selected locations is at a corner of the sheet defined by first and second intersecting portions of the periphery,
the first portion of the corresponding tape piece is attached along the first portion of the periphery and the second portion of said tape piece is attached along the second portion of the periphery, and
the intermediate portion of said tape piece forms a defined loop sized for engagement with a corresponding anchor.

4. The improved sheet according to claim 1, wherein:
at least one of the selected locations is at a corner of the sheet defined by first and second intersecting portions of the periphery,
the first portion of a corresponding tape piece is attached adjacent the first portion of the periphery and the second portion of said tape piece is attached adjacent the second portion of the periphery, and
said tape piece is disposed symmetrically relative to the corner.

5. The improved sheet according to claim 1, wherein:
the sheet and the plurality of the tape pieces all comprise the same material, so that they all present essentially the same appearance.

6. The improved sheet according to claim 1, wherein:
the tape pieces and the sheet are made of different materials; and
the tape pieces are wrapped inside and fully covered by corresponding pieces of the sheet material.

7. The improved sheet according to claim 1, wherein:
each tape piece located at a corner of the sheet is doubled over and aligned along a bisector of the corresponding angle at the corner, and
the end portions of each tape piece are attached to the sheet one over the other, such that the unattached intermediate portion between them defines a loop sized to securely engage with a corresponding anchor.

8. The improved sheet according to claim 1, wherein:
each tape piece located other than at a corner is doubled over and aligned perpendicular to the adjacent periphery, and
the end portions of each tape piece are attached to the sheet one over the other, such that the unattached intermediate portion between them defines a loop sized to securely engage with a corresponding anchor.

9. The improved sheet according to claim 1, further comprising:
a plurality of anchors, each comprising a body that has two legs joined to each other by an intermediate portion, each leg having a distal end that is forcibly pushed into ground to secure the sheet thereat.

10. The improved sheet according to claim 1, wherein:
the top surface of the improved sheet is provided with at least one of an easily remembered and recognizable color and a distinctive pattern.

11. The improved sheet according to claim 10, wherein:
the top surface of the improved sheet is provided with a promotional visual display.

12. An improved sheet having a top side, a bottom side, and a predetermined shape defined by a periphery, adapted for secure location to ground by a plurality of anchors, wherein the improvement comprises:
a length of a flexible tape attached along the periphery on the bottom side of the sheet, with portions of the tape at selected locations being left unattached to the sheet to form respective loops each sized to securely engage a corresponding anchor thereat.

13. (canceled)

14. The improved sheet according to claim 12, wherein:
each of the unattached portions of the tape is longer than a separation along the sheet between the adjacent attached portions thereof, so that the sheet during use can be disposed flatly above an anchor engaging the tape thereat.

15. The improved sheet according to claim 12, further comprising:
a plurality of anchors, wherein each anchor comprises a body including two generally parallel straight cylindrical legs joined to each other by an intermediate portion.

16. The improved sheet according to claim 15, wherein:
each leg is provided with means for enhancing its retention to ground during use, selected from a group consisting of a distal barbed-end, a plurality of circumferential barb rings along its length, and a plurality of longitudinally and circumferentially distributed bumps along its surface.

17. The improved sheet according to claim 12, wherein:
the top surface of the improved sheet is provided with at least one of an easily remembered and recognizable color and a distinctive pattern.

18. An item for promoting an enterprise or an event, comprising:
a sheet having a top side, a bottom side and a periphery;
a plurality of pieces of flexible tape, each tape piece having respective first and second ends and a predetermined respective length between the two ends, strongly attached at respective first and second end portions to the bottom side of the sheet at selected locations close to the periphery, with an intermediate portion of each tape piece left unattached for engagement with a respective anchor, so that when the sheet is thereby anchored to ground with its top side uppermost only the sheet will be visible;
a plurality of anchors, wherein each anchor comprises a body consisting of a head portion and a leg portion, the leg portion being formed with a distal end securely engageable with a corresponding tape piece and securely locatable into ground to anchor the sheet flat to the ground thereat; and
the top surface of the sheet is provided with at least one of an easily remembered and recognizable color and a distinctive pattern, the same being selected to visually promote the enterprise or event.

19. A method of promoting public awareness of an enterprise or event, and of thereby building customer and patron goodwill, comprising the steps of:
adapting a sheet for engagement with a plurality of ground anchors, by permanently attaching to the sheet adjacent its periphery a selectively distributed corresponding plurality of strong flexible tape pieces, the tape pieces being affixed to the sheet at their respective end portions with respective intermediate portions of the tape pieces left unattached to define anchor-engagement loops to engage with respective anchors thereat, the material of the tape pieces being selected to have a color and a texture appropriate to a color and the texture of the sheet;
providing the plurality of ground anchors sized and shaped to engage with individual anchor-engagement loops and be disposed out of sight in engagement with ground beneath the sheet during use;
providing on the top of the sheet a distinctive visual message promoting the enterprise or event, and
purposefully making the adapted sheet available to potential users.

20. The method according to claim 19, wherein:
the sheet is made available to customers and patrons by a goodwill improvement technique selected from a group of techniques consisting of selling at a discounted price during a promotion campaign, renting the sheet for a selected time, lending the sheet temporarily, giving away the sheet as a bonus for customer loyalty, giving away the sheet in conjunction with the sale of a particular item, and giving away the sheet in conjunction with the sale of a particular service.

21. The method according to claim 19, wherein:
the end portions of the tape pieces are folded over and disposed for attachment on opposite sides of the sheet over the adjacent periphery so as to sandwich the sheet therebetween.

22. An improved sheet having a top side, a bottom side, and a periphery defining a predetermined shape, adapted for secure location to ground by a plurality of anchors, wherein the improvement comprises:
a plurality of pieces of flexible tape, of color and texture corresponding to the material of the sheet and of predetermined width, each tape piece having respective first and second ends and a predetermined respective length between the two ends, strongly attached at respective first and second end portions to opposite sides of the sheet sandwiched therebetween at selected locations close to the periphery, with an intermediate portion of each tape piece left unattached for engagement with a respective anchor,
so that, when the sheet is anchored to ground with its top side uppermost, essentially only the top side of the sheet will be noticeable to a viewer during use.
